(19) United States
(12) Patent Application Publication
(10) Pub. No.: US 2004/0098455 A1
(43) Pub. Date: May 20, 2004

(54) Method and apparatus for controlling communications between subscriber units

(75) Inventors: John T. Ellis, Oak Lawn, IL (US); James P. Krakora, Gilbert, AZ (US); Jheroen P. Dorenbosch, Paradise, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/294,128

(22) Filed: Nov. 14, 2002

(51) Int. Cl. G06F 15/16; G06F 15/173

(52) U.S. Cl. 709/204; 709/225; 709/229

(57) ABSTRACT

A controller 103 in a communications system (FIG. 1) for controlling communications with a group 125 of associated subscriber units and method thereof, where the controller includes a receiver (part of 603) operable to receive a request for a subscriber unit to communicate with the group of associated subscriber units; and a processor 605 coupled to the receiver and operable as a comparator 619 to provide a comparison of a first association constraint (FIG. 3) corresponding to the subscriber unit and a second association constraint (FIG. 4) corresponding to the group; and a decision function 621 that allows, only when the comparison is favorable, communications between the subscriber unit and any other subscribers of the group of associated subscribers that also have such communications allowed or enabled.

### FIELD OF THE INVENTION

This invention relates in general to communication systems and more specifically to methods and apparatus for controlling communications between subscriber units in a communications system.

### BACKGROUND OF THE INVENTION

Communications systems and communications between subscriber units operating therein are known. Cellular systems and subscriber units operating therein are one example of a wireless communications system. Other systems that provide cellular like services and in addition offer a service known as Group Call are available. For a group call the group has identified members of the group and when a group call is originated by one member all other members of the group that can be reached are called and can participate in the call. No choice is left to the user or subscriber once they become a member of the group, other than disabling their subscriber unit. Additionally a non-member is not able to participate in a conventional group call. Another service that has been contemplated for systems is a “chat” room where all subscribers that have access, e.g. are allowed to communicate, communicate to all other members. Often access is controlled by an access code, which must be provided by the service provider, remembered, and entered by the subscriber in order to access the service. A need exists for a more flexible way of controlling communications in a communications system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a communications system suitable for controlling communications among subscribers or groups of associated subscribers;

FIG. 2-FIG. 5 illustrates in exemplary and tabular form various associate identifiers, association constraints, and subscriber and group relationships for use in the communications system of FIG. 1;

FIG. 6 depicts a block diagram of a preferred embodiment of the controller for controlling communications in the communications system of FIG. 1;

FIG. 7 depicts a flow chart of a preferred method embodiment of controlling communications among groups of subscribers in the communications system of FIG. 1; and

FIG. 8 depicts another flow chart of a method embodiment of controlling communications among subscriber units in the communications system of FIG. 1.

### DETAILED DESCRIPTION OF PREFERRED EMBODIMENTS

In overview form the present disclosure concerns systems, methods, and equipment or apparatus that provide communications services to users of such systems and equipment and specifically techniques for controlling communications among subscriber units or groups of subscriber units in a communications system. More particularly various inventive concepts and principles embodied in system controllers and methods therein or subscriber units or devices for controlling communications in a communications system within a group, such as a chat group and the like as well as among subscriber units in a reasonable fashion taking into consideration various relevant factors regarding the service provider and users thereof all for the convenience and advantage of users or consumers and providers of services are discussed and described. The systems, equipment, and the like rely on some form of connectivity, thus network that may be any combination of wired and wireless networks. Networks of particular interest may be organized on a wide area network (WAN) or local area network (LAN) basis generally in a structured manner and should be suitable for modest bandwidth communications. It is expected that a preferred form of access to this network by user equipment and associated users thereof is via a wireless protocol or extensions thereof such as may be found in systems such as an integrated digital enhanced network, commercially known as an iDEN™ communications system available from Motorola Inc. or more conventional cellular networks.

As further discussed below various inventive principles and combinations thereof are advantageously employed to control communications and selectively and dynamically allow certain communications, thus alleviating various problems associated with known systems that ignore problems or rely on fixed inflexible approaches, thereby advantageously facilitating a fair and reasonable approach to controlling communications from and among subscribers or users, provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs and instructions. It is expected that one of ordinary skill, notwithstanding possibly significant effort and many design choices motivated by, for example, available time, current technology, and economic considerations, when guided by the concepts and principles disclosed herein will be readily capable of generating such software instructions with minimal experimentation. Therefore, in the interest of brevity and minimization of any risk of obscuring the principles and concepts according to the present invention, further discussion of such software, if any, will be limited to the essentials with respect to the principles and concepts used by the preferred embodiments.

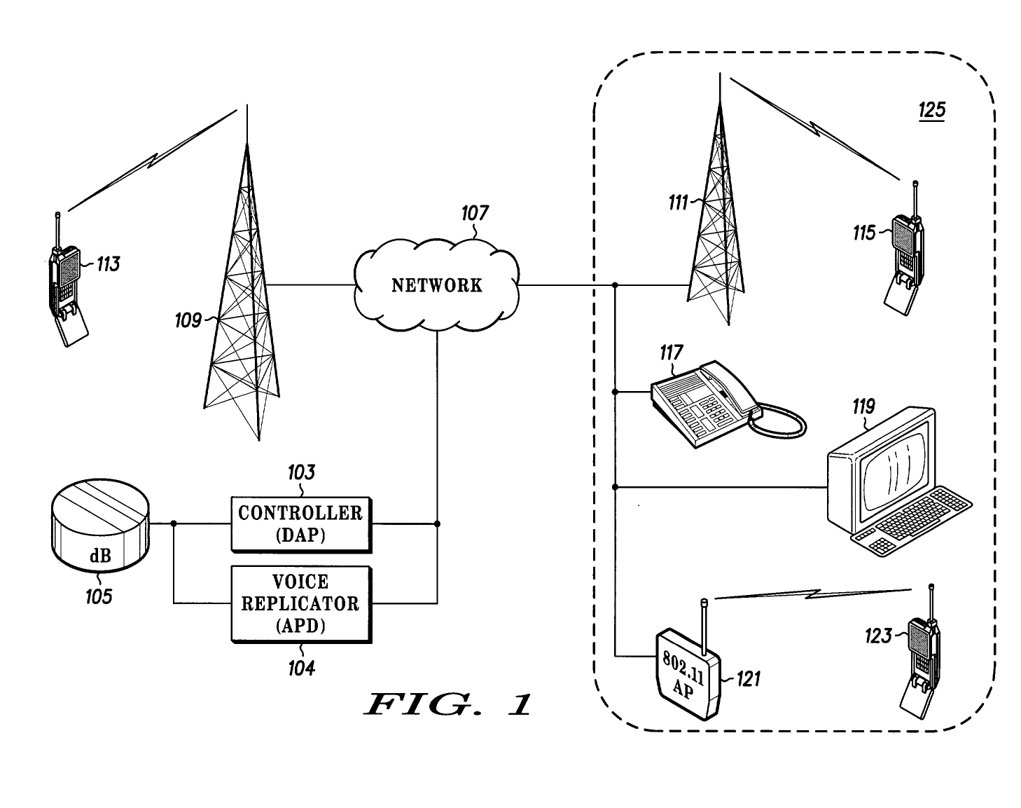

Referring to FIG. 1, a simplified and representative system level diagram depicting a communications system arranged and constructed and suitable for controlling communications among subscribers or groups of associated subscribers will be discussed and described. The communications system shown in FIG. 1, while indicative of or representative of a wide variety of differing systems and evolutions of such differing systems, is operable as a dispatch communications system or system suitable for supporting dispatch calls and services typically found in dispatch systems. One such exemplary system is an iDEN™ communications system, available from Motorola Corporation. However, the system may be any dispatch system such as a QCHAT™ system, available from QUALCOMM, a GSM Pro from Ericsson, TETRA from Nokia, or any cellular, specialized mobile radio (SMR) or enhanced specialized mobile radio (ESMR) system that provides or desires to provide control of communications among subscribers or groups of subscribers, such as group calls or phone conferences over the public switched telephone network or text based chat groups over the Internet provided the concepts and principles described herein are adhered to as further described below in detail.

The diagram shows a system including a controller or digital application processor (DAP) 103 and voice replicator 104 APD (Audio Packet Duplicator) that are cross-coupled and further coupled to a database 105 and distribution network 107. The distribution network 107 is coupled to one or more radio access networks 109, 111 that support distribution or communications with one or more subscriber units 113, 115 such as wireless cellular or iDEN™ handsets or devices. The distribution network 107 is further depicted with wire line distribution capability, via the subscriber unit or Internet phone 117 and a subscriber unit or software based phone on a personal computer 119 as well as IEEE 802.11 capability, via an 802.11 access point (AP) 121 coupled in an ad hoc local area network configuration to an 802.11 subscriber unit 123. Note there may be one or more gateways and the like (not shown) that facilitate interfaces between one or more of the r 802.11 APs 121 and the network 107, and so on. Generally the network elements are known with the controller responsible, for example, for scheduling communications and resources such as radio access networks, traffic channels, and controlling access to or through the network by the various subscriber units. The controller 103 is preferably a fault tolerant redundant multi-processor based computer platform, such as, for example, a Compaq Tandem computer platform on which appropriate application software including, for example, dispatch application software all modified according to the concepts and principles herein is integrated and executing. The APD duplicates or replicates the audio or traffic from a transmitting or talking subscriber unit and makes it available to each of the other subscriber units that should be involved in a communications or call. However, as we will discuss, various modifications to known controllers according to the principles and concepts herein discussed and explained will be required in order to advantageously control communications as herein contemplated.

Note that the plurality of communications or subscriber units, or devices are exemplary only and may include a plurality of cellular handsets or such handsets with dispatch capabilities, messenger devices, personal digital assistants (PDA), portable computers, voice over IP phones and the like, each with voice or data communications capabilities and each with a corresponding user (not depicted).

These subscriber units or devices and associated users thereof are coupled in various generally known manners to the network 107 along with various other entities or resources or units not shown. The subscriber units 115, 117, 119, and 123 are shown as an associated group of subscriber devices or chat group 125. Note that many such groups may exist and that any one subscriber may be associated with multiple groups or chat rooms and may as well be a more or less static member of other groups for group calls. Of course in a text-based chat room, the communications device are normally a personal computer, laptop computer, two way messaging device, text-enabled phone, PDA, and so forth.

Generally a group call is a call that may only be placed by a member of a group and all other members of the group are part of the call, assuming in some instances they respond to an invite message. The group may be defined in various known fashions but typically will include a membership list stored at some database either within the subscriber unit or within the infrastructure, such as the database 105. Generally the group call, while it could be a full duplex call, is better implemented as a dispatch call in a half duplex manner wherein one user or subscriber unit is able to (transmit) at any one time with all other units listening (receiving) at that instant in time. This dispatch group call is usually set up and managed via the controller 103. A user that wants to talk sends in a request to talk on a control channel. The controller at the proper time issues or grants a right to talk via the control channel. Usually the proper time includes a time after a current talker has released the channel via discontinuing a transmission. Typically the request to talk is initiated via activation of a push to talk (PTT) button by the user at one of the subscriber units, a grant or notification of a right to talk will include an audible signal at the user's unit or device and the unit will thereafter be allowed to begin a transmission. A release of the PTT button will release the traffic channel. The half duplex mode provides certain advantages such as the same channel at radio access network 109 can be used for multiple subscriber units at that location.

A chat room or chat type of call to an associated group is different in that, a subscriber unit must first join the chat room or call and once joined will receive all transmissions from other subscriber units that have also joined and will ordinarily be allowed to transmit to all units that have likewise joined. In the end this amounts to the controller selectively allowing or enabling communications from and to a subscriber unit, respectively, to and from any other subscriber units that have joined the chat room or call. The chat call or chat room is often handled in a half duplex mode as explained above, provided the system is dispatch equipped or capable of supporting half duplex, but can be handled as a full duplex call. A subscriber unit joins the chat room or chat call by indicating a desire to do so by, for example, selecting a chat room name and sending a corresponding request. If the chat room is an open or public chat room the controller will hence forth route communications traffic, voice and data, to and from the subscriber unit making the request to the other subscriber units that have joined the chat room. Historically, non-public chat calls or chat rooms have additionally required a subscriber unit via a user to enter and supply a password or access code that the controller can compare to an access code for the chat room and if a match is found the unit is allowed access or allowed to communicate. Another approach is the maintenance of a list of units allowed to join (white list) or list of units not allowed (black list). For large chat rooms with many potential subscriber units the issuing and informing of proper users of the correct access codes or maintenance of the lists is a major burden for a service provider or group or chat room administrator. The concepts and principles disclosed herein may be advantageously applied to reduce or eliminate these burdens.

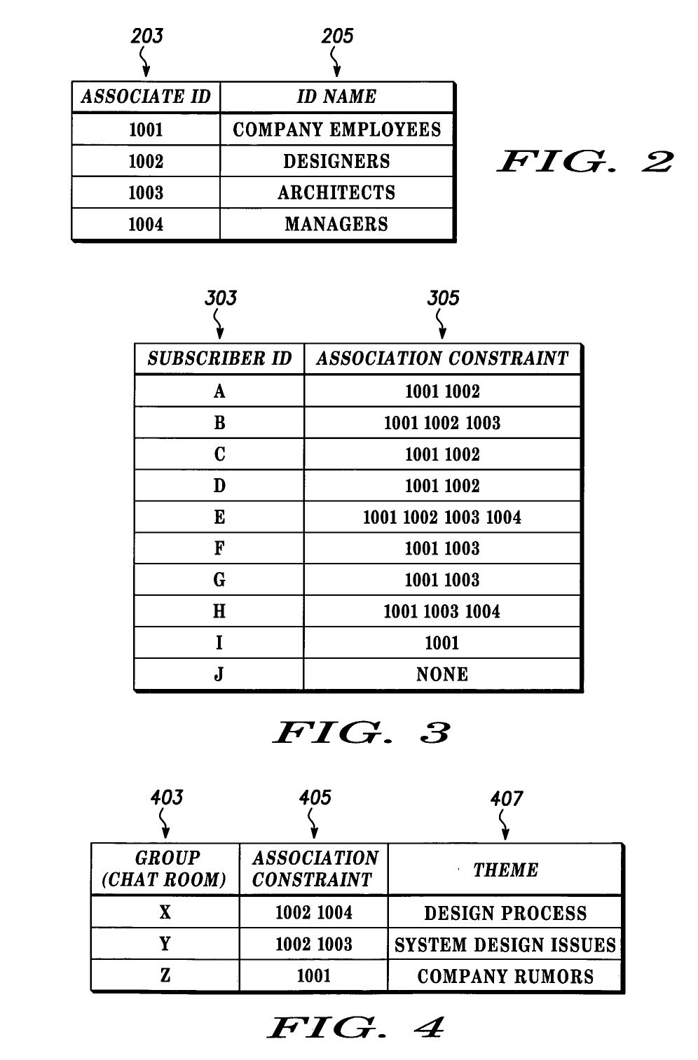

Referring to FIG. 2-FIG. 5, various illustrations, in exemplary and tabular form, of associate identifiers, association constraints, subscriber and group relationships for use in the FIG. 1 system will be discussed and described. FIG. 2 shows a novel entity, referred to as an associate identifier (ID) 203 with four such IDs listed, namely 1001, 1002, 1003, and 1004. These are dimensionless identities that may be stored with or at particular subscriber devices but, preferably, are retained or stored at a database, such as database 105 along with other system and subscriber information. These associate IDs may include other information, such as a descriptive name or ID name 205 as depicted. FIG. 3 shows a listing of subscriber unit identifiers 303, namely A-J, together with, respective, association constraints 305. For example the subscriber unit designated D has an association constraint defined as associate IDs 1001, 1002 and subscriber unit F has a corresponding association constraint comprising associate IDs 1001, and 1003. For example, subscriber unit D may be utilized by a company employee (1001) that is or is identified as a designer (1002), while subscriber unit F may correspond to an employee (1001) that is identified as an architect (1003).

Note that subscriber unit J does not have any listed associate IDs. Depending on conventions adopted this could be indicative, as it seems to suggest, of no association constraints, e.g. sort of a wild card associate ID, allowing the unit to participate in any controlled communications, such as might be the case for the chief executive officer or the like for an organization. More likely, given the administrative practicalities, it signifies no associate IDs and thus no participation allowed. For example, perhaps a subscriber unit corresponding to a contract employee of the company that is not allowed to participate in either group or chat calls where communications is controlled although, the unit would presumably have access to public chat calls or rooms. In any event and although not shown it is likely that certain blanket association constraints would be identified or defined, such as 9999 for a wild card, etc.

FIG. 4 illustrates in tabular and exemplary form a listing of groups or chat rooms 403 together with corresponding association constraints 405 and a descriptive title or theme 407 for the group or chat room. For example, chat room X has an association constraint comprised of associate IDs 1002, 1004 and concerns design processes while chat room or group Z has an association constraint comprised of associate ID 1001 and concerns the company rumor mill. Note that certain subscribers have an association constraint that matches vis-a-vis one or more associate IDs the association constraint, specifically associate IDs corresponding to a group or chat room. This observation will be used advantageously to control communications among the various subscriber units or associated groups thereof as will explain in further detail below.

FIG. 5 illustrates another listing of Group ID/group name 503, specifically 100/Service group Y together with a membership list 505 comprising members SP1, SP2, and SP3 as well as an association constraint corresponding to the group, namely 2001. This will be shown to facilitate a communications exchange with the group 100 by a subscriber unit that is not a member of the group.

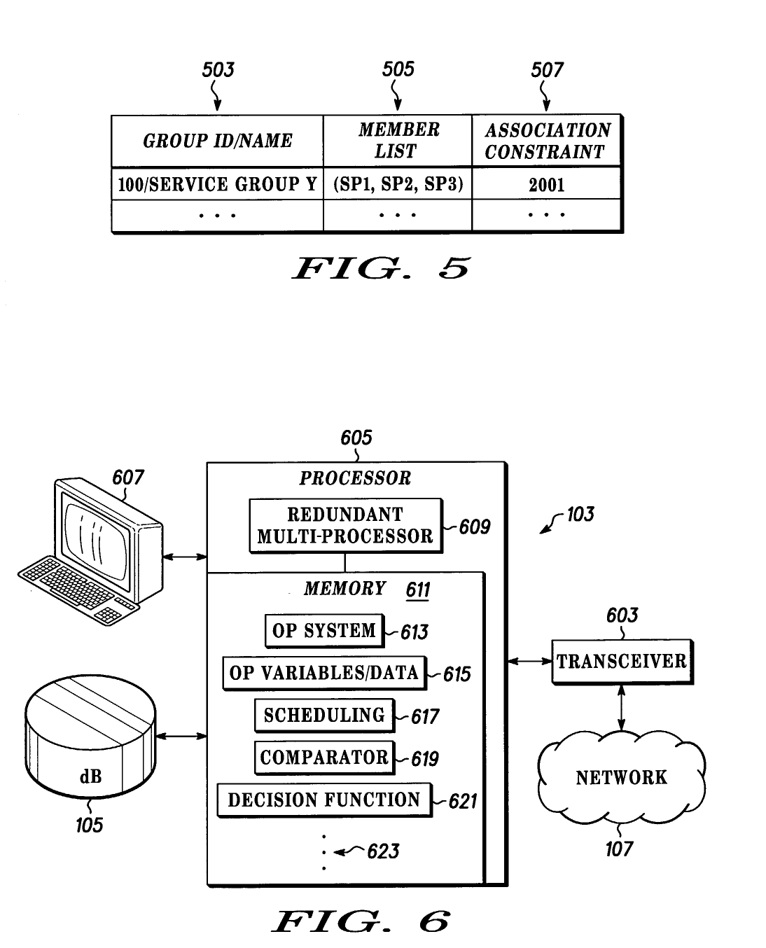

Referring to FIG. 6, a block diagram of a preferred embodiment of the controller 103 for controlling communications with a group of associated subscriber units or among subscriber units in the communications system of FIG. 1 will be discussed and described. The controller 103, as noted above, is for use in a communications system including specifically a dispatch communications system or system with dispatch-like capabilities and is arranged and constructed for controlling communications under various circumstances in the communications system. The controller includes, coupled to and from the network 107, a transceiver 603 comprising a receiver and transmitter that is further inter coupled to a processor 605. The transceiver 603 is preferably a wire line transceiver such as an Ethernet transceiver suitable for packet data communications as well as an audio transceiver. The processor 605 is inter coupled to an operator input output 607, such as a conventional computer monitor and keyboard. The processor includes a conventional reasonably high capacity fault tolerant microprocessor based unit 609 with one or more microprocessors.

The processor 605 further includes a memory 611 that includes various software routines and instructions and data that when executed by the processor based unit 609 results in the controller controlling and managing the communications system and implementing a method, discussed further below, of controlling communications as appropriate in a group or chat call or in one on one communications between subscriber units. The memory includes various known RAM, ROM, EPROM, and magnetic memory elements such as hard drives and the like and may include the database 105 and in any event at least has access to the database via the processor, etc. The software routines within the memory include an operating system 613, various operating variables, parameters, and date 615, scheduling routines 617, a comparator routine 619, a decision function or routine 621, as well as various other software routines and information 623 not here relevant but obvious to one of ordinary skill.

In operation the controller 103, specifically processor 605, cooperatively with the transceiver 603 or receiver, operates to control communications with or among a group of associated subscriber units. The receiver (part of the transceiver 603) is operable to receive a request for a subscriber unit to communicate with the group of associated subscriber units. This request may come from another subscriber unit and result more or less in an invite to the subscriber unit for such communication, however it is likely to come from the subscriber unit, such as subscriber unit 115, 119, etc. In any event the processor 605 that is inter coupled to the receiver is further operable: as a comparator, by virtue of the comparator routine etc., to provide a comparison of a first association constraint corresponding to the subscriber unit (see FIG. 3) and a second association constraint corresponding to the group (see FIG. 4); and as a decision function, by virtue of routine 621, that allows, only when the comparison of the first association constraint and the second association constraint is favorable, communications between the subscriber unit and any other subscribers of the group of associated subscribers that also have such communications allowed.

As noted when FIG. 3 and FIG. 4 were discussed one of the first association constraint or the second association constraint may include, respectively, a plurality of first associate identifiers (IDs) and second associate IDs in which case the comparator will provide the comparison that is favorable or a favorable comparison when any one of the plurality of first associate IDs matches any one of the second associate IDs. Thus the decision function allows the communications when any one of the first associate IDs matches any one of the second associate IDs. By way of example referring to FIG. 3 and FIG. 4, suppose subscriber A requests to communicate with the group of associated subscribers, known as group or chat room X. The first association constraint corresponding to subscriber A is the plurality of associate IDs, 1001, 1002 and the association constraint corresponding to chat room X is the associate IDs 1002, 1004. Since both association constraints include the same associate ID, 1002, the communications would be allowed and subscriber A could now communicate with any subscriber that has also been allowed to and has joined group X.

In order to compare the respective association constraints, these constraints must be obtained. One may obtain the first association constraint from the subscriber unit by, for example, the receiver further receiving the first association constraint from the subscriber unit. This may occur together with receiving the request to communicate, for example, from the first subscriber unit or as a result of a query to the first subscriber unit if the request to communicate has been forwarded from another subscriber unit. Preferably, however the association constraint is stored in a database that includes information for the subscriber unit including the first association constraint and that includes information for the group of associated subscriber units including the second association constraint. The database may be stored in the memory of the controller 103 or a memory associated with the controller such as the database 105 or another database that may be co-located or otherwise with respect to the controller 103. Such information is likely to be permanently stored for each subscriber unit in a home database often referred to as a home location register and this database is likely maintained by the respective subscriber unit's service provider, which may or may not correspond to the controller 103. In summary, the various association constraints may be stored in a plurality of databases in a plurality of locations. In any event the association constraints is obtained and stored in the memory 611 in order for the comparison to be made. As noted above, dependent on system conventions, the first association constraint may include a wild card identifier that operates to enable communications between the subscriber unit and any group of associated subscriber units.

Also it should be noted that association constraints and associate IDs can be used in conjunction with access codes or lists of allowed and disallowed subscriber units. In that event the receiver is further operable to receive an access code and the decision function further enables the communications only when a code comparison between the access code and a group access code is favorable, e.g. matches. The request to communicate received by the receiver may be a request to join an ongoing communications, such as chat room, among the many other subscribers of the group of associated subscribers that also have such communications allowed.

The controller 103 operating as above noted may also be used to allow communications from a non member subscriber with a group such as discussed with reference to FIG. 5 above. In that case the group of associated subscribers would have a group identifier (ID) such as 100, each of the associated subscriber units, such as SP1, SP2, and SP3 would be a member of the group, the subscriber unit requesting the communications would not be a member of the group, the second association constraint, for example 2001 would corresponds to the group ID, and all of the members of the group have the communications allowed for communications within the group and thus from the non member subscriber unit provided association constraints favorably compare. In this instance the decision function allows the subscriber unit that is not a member of the group to communicate with the group when the first association constraint compares favorably to the second association constraint, 2001. E.g. if the association constraint for the subscriber unit includes an associate ID equal to 2001 it will be allowed to communicate, thus allowing a non member of the group to communicate with the group. The communication with the group may be limited, such as, having the decision function limit the communications with the group to communications from the subscriber unit to the group or wherein the decision function allows the communications with the group including communications from a member of the group to the subscriber unit as well as other members of the group.

In another important aspect the controller 103 operates in a communications system for controlling communications among subscriber units. The receiver, part of transceiver 603, is operable to receive, from a first subscriber unit, a request for one on one communication with a second subscriber unit; and the processor 605 is operable as: a comparator to provide a comparison of a first association constraint corresponding to the first subscriber unit and a second association constraint corresponding to the second subscriber unit. The processor 605 is further operable as a decision function that allows, only when the first association constraint compares favorably to the second association constraint, one on one communication between the first subscriber unit and the second subscriber unit.

The first association constraint and the second association constraint each define, respectively, arbitrary associations between the first subscriber unit and first other subscriber units and between the second subscriber unit and second other subscriber units. Note that this arbitrary association defined by the association constraints as herein contemplated is distinct from known Fleet Identifiers or system identifiers, for example, where there was nothing arbitrary about the fleet or system identities. If a subscriber unit was purchased by or as part of a fleet or if a subscriber unit was using a system as the home system, the fleet ID or system ID associated with the subscriber unit was predetermined and inflexible. In contrast the association constraints define associations amongst small groups of subscriber units and these constraints are readily updated or changed as circumstances for a particular unit change.

In any event, as above either the first association constraint or the second association constraint may include, respectively, a plurality of first associate IDs and second associate IDs and the comparator may provide a favorable comparison when any one of the plurality of first associate IDs matches any one of the second associate IDs. The receiver that is operable to receive the request from the first subscriber unit may further receive the first association constraint from the first subscriber unit. Alternatively and preferably the controller further includes or has access to a memory for storing a database that includes information for the first subscriber unit and the second subscriber unit, the information including, respectively, the first association constraint and the second association constraint. Even when there is a favorable comparison the decision function may be arranged to allow only limited communications. For example, the decision function may only allow the first subscriber unit to initiate communications with the second subscriber unit when a comparison of the first association constraint with the second association constraint is favorable while the first subscriber unit is allowed to be the recipient of communications regardless of a comparison result between any association constraint and the first association constraint. Or the decision function may only allow the second subscriber unit to be the recipient of a communications when an other comparison of another association constraint with the second association constraint is favorable while the second subscriber unit can originate communications regardless of the other comparison.

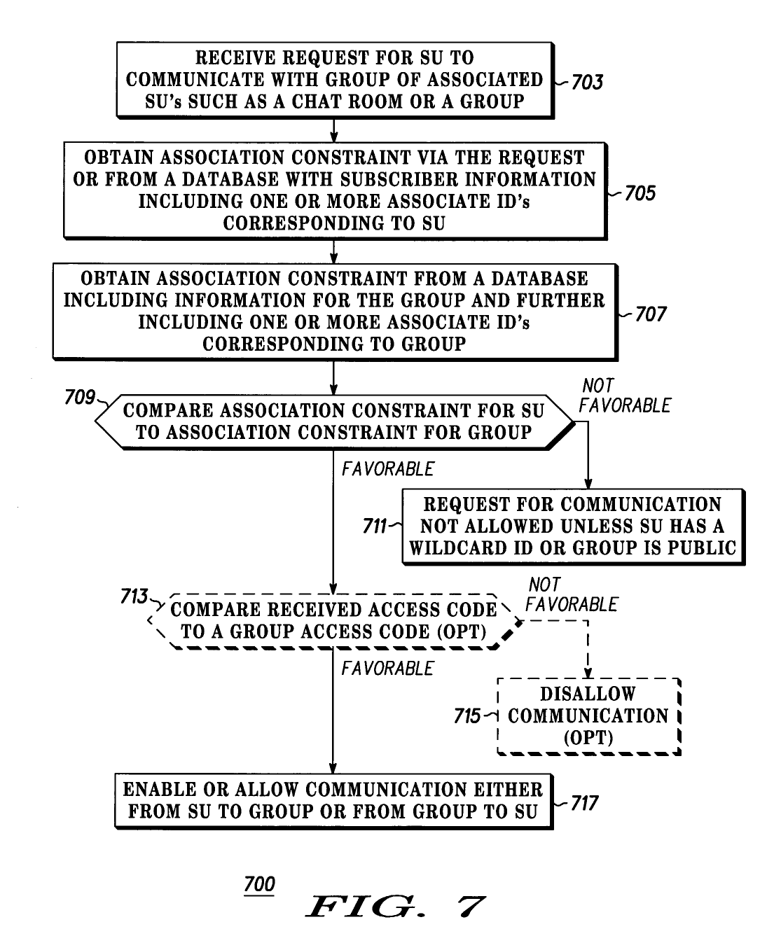

Referring to FIG. 7, a flow chart of a preferred method embodiment of controlling communications, by a controller such as controller 103, among groups of subscribers in the communications system of FIG. 1 will be discussed and described. Note that this method is similar to the method practiced by the controller as discussed above and thus this discussion will be at an overview level. FIG. 7 depicts a method 700 of controlling communications with a group of associated subscriber units in a communications system. The method begins at 703 with receiving a request for a subscriber unit, possibly from the subscriber unit, to communicate with the group of associated subscriber units. The request may comprise a request to join an ongoing communications such as a chat room or as may be encountered in a chat room or a dispatch group or the like. At 705 the method shows obtaining the first association constraint either from the subscriber unit and the request or, preferably, from a database 105 within the infrastructure such as the controller 103 or database 105 that includes information for the subscriber unit. At 707 the method shows obtaining the second association constraint from a database that includes information for the group of associated subscriber units. In each case obtaining the first association constraint and obtaining the second association constraint may further include, respectively, obtaining a plurality of first associate identifiers (IDs) and second associate IDs.

In any event 709 depicts comparing the first association constraint corresponding to the subscriber unit to the second association constraint corresponding to the group. If the comparison is not favorable, at 711 the request for communication is not allowed unless the subscriber unit's association constraint is a wild card ID or the group is a public group e.g. one without these limitations on association. If the comparison is favorable, optional process 713 shows comparing an access code preferably received together with the request to a group access code. If the comparison is not favorable, the request is disallowed at optional process 715. If the comparison is favorable process 717 shows enabling, only when the first association constraint compares favorably to the second association constraint, communications between the subscriber unit and any other subscribers of the group of associated subscribers that also have such communications enabled. A favorable comparison results when any one of the plurality of first associate IDs matches any one of the second associate IDs or when a wild card ID is found.

The method 700 may be used to allow a novel communication between a non-member subscriber unit and a dispatch group of subscriber units. To do so requires: the group have a group identifier (ID); each of the associated subscriber units be a member of the group; the subscriber unit corresponding to the request not be a member (i.e. non-member) of the group; the second association constraint corresponds to the group ID; and all of the members of the group have communications enabled among the group which by definition is the case for a dispatch group. Under these circumstances, the subscriber unit that is not a member of the group may be allowed to communicate with the group when the first association constraint corresponding to the subscriber unit compares favorably to the second association constraint corresponding to the group ID. The communication with the group may be limited to communications from the subscriber unit to the group or the communications with the group may include communications from a member of the group to the subscriber unit and other members of the group.

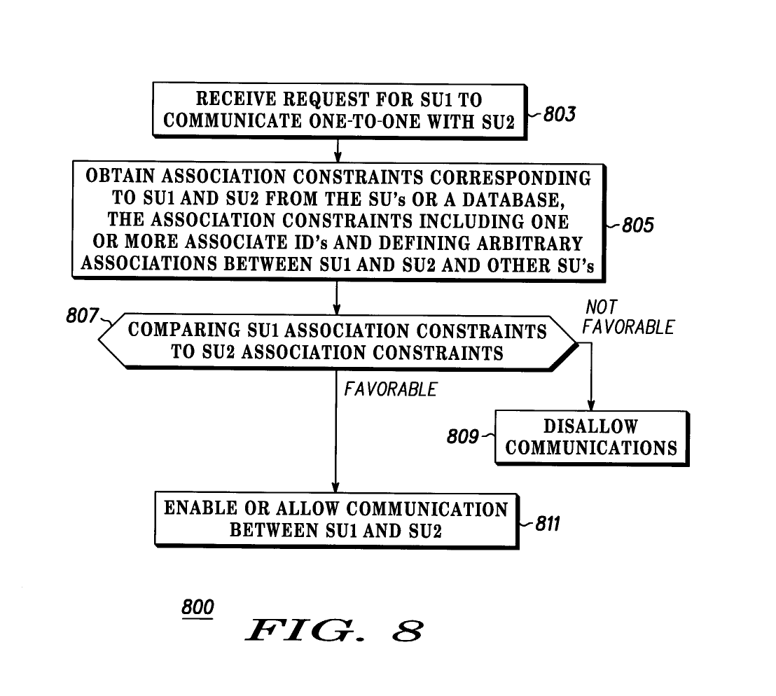

Referring to FIG. 8, another flow chart of a method 800 embodiment of controlling communications among subscriber units in the FIG. 1 system will be discussed and reviewed. The method 800 begins at 803 with receiving, from a first subscriber unit, a request for one on one communication with a second subscriber unit. Then, 805 shows obtaining association constraints that correspond to the first and second subscriber units. The first association constraint may be received with the request from the first subscriber unit. Preferably as has been discussed, the first association constraint and the second association constraint are obtained from a database that includes information for the first subscriber unit and the second subscriber unit. Note that either the first association constraint or the second association constraint may include, respectively, a plurality of first associate identifiers (IDs) and second associate IDs. Here and as earlier discussed the first association constraint and the second association constraint, respectively, define arbitrary associations between the first subscriber unit and first other subscriber units and between the second subscriber unit and second other subscriber units.

At 807, the method shows comparing the first association constraint corresponding to the first subscriber unit to the second association constraint corresponding to the second subscriber unit. A favorable comparison results when any one of the plurality of first associate IDs matches any one of the second associate IDs. If the comparison is unfavorable, 809 shows disallowing the requested communications. If the comparison is favorable, 811 indicates allowing or enabling, only when the first association constraint compares favorably to the second association constraint, one on one communication between the first subscriber unit and the second subscriber unit. The extent of the communications may be further constrained or limited. For example, the first subscriber unit may be only allowed to initiate communications with the second subscriber unit when a comparison of the first association constraint and the second association constraint is favorable, while the first subscriber unit may be the recipient of communications regardless of a comparison result between any association constraint and the first association constraint. Or, by way of another example, the second subscriber unit may only be the recipient of a communications when a comparison of another association constraint with the second association constraint is favorable while the second subscriber unit may be able to originate communications regardless of the comparison.

The apparatus, processes, and systems described and discussed above and the inventive principles thereof are intended to and will alleviate problems caused by prior art communications control techniques that used relatively fixed inflexible approaches such as access codes or list of allowed or disallowed subscriber units ignoring all else to the disadvantage and dismay of users of the systems. Using the above discussed principles and concepts of controlling communications among chat groups or dispatch groups only under appropriate circumstances will facilitate services and calls that are effective, efficient and friendly thus contributing to user satisfaction and lowering time wasted by large groups of people with inappropriate participants. It is expected that one of ordinary skill given the above described principles, concepts and examples will be able to implement other alternative procedures that are situation dependent and that will also offer additional quick and efficient communications control procedures. It is anticipated that the claims below cover many such other examples, such as telephony conferences and text-based chat groups.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of controlling communications with a group of associated subscriber units in a communications system, the method comprising:
receiving a request for a subscriber unit to communicate with the group of associated subscriber units;
comparing a first association constraint corresponding to the subscriber unit to a second association constraint corresponding to the group; and
enabling, only when the first association constraint compares favorably to the second association constraint, communications between the subscriber unit and any other subscriber unit of the group of associated subscriber units that also have such communications enabled.

2. The method of claim 1, wherein:
the group has a group identifier (ID), each of the associated subscriber units is a member of the group, the subscriber unit is not a member of the group, the second association constraint corresponds to the group ID, and all of the members of the group have the communications enabled; and
the subscriber unit that is not a member of the group is allowed to communicate with the group when the first association constraint compares favorably to the second association constraint.

3. The method of claim 2 wherein the communications between the subscriber unit and any other subscriber unit of the group of associated subscriber units is limited to communications from the subscriber unit to the group.

4. The method of claim 2 wherein the communications between the subscriber unit and any other subscriber unit of the group of associated subscriber units includes communications from a member of the group to the subscriber unit and other members of the group.

5. The method of claim 1 wherein one of the first association constraint and the second association constraint further comprises, respectively, a plurality of first associate identifiers (IDs) and second associate IDs and a favorable comparison results when any one of the plurality of first associate IDs matches any one of the second associate IDs.

6. The method of claim 1, wherein the receiving the request further comprises receiving the request from the subscriber unit.

7. The method of claim 6, wherein the receiving the request from the subscriber unit further comprises receiving the first association constraint from the subscriber unit.

8. The method of claim 1 further comprising, obtaining the first association constraint from a database that includes information for the subscriber unit and obtaining the second association constraint from a database that includes information for the group of associated subscriber units.

9. The method of claim 8 wherein one of the obtaining the first association constraint and obtaining the second association constraint further comprises, respectively, obtaining a plurality of first associate identifiers (IDs) and second associate IDs and the enabling the communications occurs when any one of the plurality of first associate IDs matches any one of the second associate IDs.

10. The method of claim 1 wherein the first association constraint includes a wild card identifier that operates to enable communications between the subscriber unit and any group of associated subscriber units.

11. The method of claim 1 wherein the receiving a request further includes receiving an access code and said enabling the communications is further conditioned on a favorable comparison between the access code and a group access code.

12. The method of claim 1 wherein the receiving a request for the subscriber unit to communicate further comprises receiving a request to join an ongoing communications among the any other subscribers of the group of associated subscribers that also have such communications enabled.

13. The method of claim 12 wherein the receiving a request to join the ongoing communications comprises receiving a request to join a chat room.

14. A method of controlling communications among subscriber units in a communications system, the method comprising:
receiving, from a first subscriber unit, a request for one on one communication with a second subscriber unit;
comparing a first association constraint corresponding to the first subscriber unit to a second association constraint corresponding to the second subscriber unit, the first association constraint and the second association constraint defining arbitrary associations between the first subscriber unit and first other subscriber units and between the second subscriber unit and second other subscriber units; and
allowing, only when the first association constraint compares favorably to the second association constraint, one on one communication between the first subscriber unit and the second subscriber unit.

15. The method of claim 14 wherein one of the first association constraint and the second association constraint further comprises, respectively, a plurality of first associate identifiers (IDs) and second associate IDs and a favorable comparison results when any one of the plurality of first associate IDs matches any one of the second associate IDs.

16. The method of claim 14 wherein the receiving the request from the first subscriber unit further comprises receiving the first association constraint from the first subscriber unit.

17. The method of claim 14 further comprising, obtaining the first association constraint from a first database and obtaining the second association constraint from a second database that, respectively, include information for the first subscriber unit and the second subscriber unit.

18. The method of claim 14 wherein the first subscriber unit is only allowed to initiate communications with the second subscriber unit when a comparison of the first association constraint and the second association constraint is favorable while the first subscriber unit can be the recipient of communications regardless of a comparison result between any association constraint and the first association constraint.

19. The method of claim 14 wherein the second subscriber unit can only be the recipient of a communications when a comparison of another association constraint with the second association constraint is favorable while the second subscriber unit can originate communications regardless of the comparison.

20. A controller in a communications system for controlling communications with a group of associated subscriber units, the controller comprising:
a receiver operable to receive a request for a subscriber unit to communicate with the group of associated subscriber units; and
a processor inter coupled to the receiver and operable as:
a comparator to provide a comparison of a first association constraint corresponding to the subscriber unit and a second association constraint corresponding to the group; and
a decision function that allows, only when the comparison of the first association constraint and the second association constraint is favorable, communications between the subscriber unit and any other subscriber unit of the group of associated subscriber units that also have such communications allowed.

21. The controller of claim 20, wherein:
the group has a group identifier (ID), each of the associated subscriber units is a member of the group, the subscriber unit is not a member of the group, the second association constraint corresponds to the group ID, and all of the members of the group have the communications allowed; and
the decision function allows the subscriber unit that is not a member of the group to communicate with the group when the first association constraint compares favorably to the second association constraint.

22. The controller of claim 21 wherein the decision function limits the communications with the group to communications from the subscriber unit to the group.

23. The controller of claim 21 wherein the decision function allows the communications with the group including communications from a member of the group to the subscriber unit and other members of the group.

24. The controller of claim 20 wherein one of the first association constraint and the second association constraint further comprises, respectively, a plurality of first associate identifiers (IDs) and second associate IDs and the comparator provides the comparison that is favorable when any one of the plurality of first associate IDs matches any one of the second associate IDs.

25. The controller of claim 20, wherein the receiver is further operable to receive the request from the subscriber unit.

26. The controller of claim 25, wherein the receiver is further operable to receive the first association constraint from the subscriber unit.

27. The controller of claim 20 further including, a memory with a database that includes information for the subscriber unit including the first association constraint and that includes information for the group of associated subscriber units including the second association constraint.

28. The controller of claim 27 wherein one of the first association constraint and the second association constraint further includes, respectively, a plurality of first associate identifiers (IDs) and second associate IDs and the decision function allows the communications when any one of the plurality of first associate IDs matches any one of the second associate IDs.

29. The controller of claim 20 wherein the first association constraint includes a wild card identifier that operates to enable communications between the subscriber unit and any group of associated subscriber units.

30. The controller of claim 20 wherein the receiver is further operable to receive an access code and the decision function further enables the communications between the subscriber unit and any other subscriber unit of the group of associated subscriber units only when a code comparison between the access code and a group access code is favorable.

31. The controller of claim 20 wherein the receiver is further operable to receive a request to join an ongoing communications among the any other subscribers of the group of associated subscribers that also have such communications allowed.

32. The controller of claim 3 1 wherein the request to join the ongoing communications is a request to join a chat room.

33. A controller in a communications system for controlling communications among subscriber units, the controller comprising:
a receiver operable to receive, from a first subscriber unit, a request for one on one communication with a second subscriber unit; and
a processor inter coupled to the receiver and operable as:
a comparator to provide a comparison of a first association constraint corresponding to the first subscriber unit and a second association constraint corresponding to the second subscriber unit, the first association constraint and the second association constraint defining arbitrary associations between the first subscriber unit and first other subscriber units and between the second subscriber unit and second other subscriber units; and
a decision function that allows, only when the first association constraint compares favorably to the second association constraint, one on one communication between the first subscriber unit and the second subscriber unit.

34. The controller of claim 33 wherein:
one of the first association constraint and the second association constraint further includes, respectively, a plurality of first associate identifiers (IDs) and second associate IDs; and
the comparator provides a favorable comparison when any one of the plurality of first associate IDs matches any one of the second associate IDs.

35. The controller of claim 33 wherein the receiver that is operable to receive the request from the first subscriber unit is further operable to receive the first association constraint from the first subscriber unit.

36. The controller of claim 33 further including a memory for storing database information that includes information for the first subscriber unit and the second subscriber unit, the information including, respectively, the first association constraint and the second association constraint.

37. The controller of claim 33 wherein the decision function only allows the first subscriber unit to initiate communications with the second subscriber unit when a comparison of the first association constraint with the second association constraint is favorable while the first subscriber unit is allowed to be the recipient of communications regardless of a comparison result between any association constraint and the first association constraint.

38. The controller of claim 33 wherein the decision function only allows the second subscriber unit to be the recipient of a communications when an other comparison of another association constraint with the second association constraint is favorable while the second subscriber unit can originate communications regardless of the other comparison.
